(19) United States
(12) Patent Application Publication
(10) Pub. No.: US 2014/0312526 A1
(43) Pub. Date: Oct. 23, 2014

(54) METHOD FOR RECYCLING ARTIFICIAL GRASS CONTAINING FIBROUS MATERIAL

(71) Applicants: Dong Hun Kwak, Gyeongsangbuk-do (KR); Kyoung Rok Kong, Gyeongsangbuk-do (KR)

(72) Inventors: Dong Hun Kwak, Gyeongsangbuk-do (KR); Kyoung Rok Kong, Gyeongsangbuk-do (KR)

(73) Assignee: KOLONGLOTECH. INC, Gyeonggi-do (KR)

(21) Appl. No.: 14/346,427

(22) PCT Filed: Sep. 26, 2011
(86) PCT No.: PCT/KR2011/007046

§ 371 Date: Jun. 30, 2014

(30) Foreign Application Priority Data
Sep. 23, 2011 (KR) 10-2011-0096519

(51) Int. Cl. B02C 23/08; B07B 13/00; B07B 9/00

(52) U.S. Cl. CPC B02C 23/08; B07B 9/00; B07B 13/00
USPC 264/176.1; 29/426.4; 264/328.17

(57) ABSTRACT

The present invention relates to a method for recycling artificial grass containing fibrous material, and comprises: a supplying step for supplying the artificial grass comprising a base material, and a yarn; a separation step for separating the filler from the artificial grass yarn and the base material; and a crushing step for crushing the yarn and the base material of the artificial grass from which the filler is separated; and a reconstruction step for forming the artificial grass yarn and the base material that are crushed into recycled material. As a result, provided is the method for recycling the artificial grass containing the fibrous material, which can completely separate the filler and foreign material from the base material and the yarn that comprise the artificial grass and recycle the artificial grass yarn, base material, and the filler, thereby preventing environmental pollution.

### TECHNICAL FIELD

The present invention relates to a recycling method of an artificial turf including a fiber structure, and more particularly, to a recycling method of an artificial turf including a fiber structure capable of preventing environmental pollution by perfectly separating a filler and foreign materials from the artificial turf to recycle the artificial turf.

### BACKGROUND ART

An artificial turf may be widely used in various outdoor stadiums or school grounds and various uses such as landscaping and decoration because maintenance is easy as compared with a natural turf.

A general artificial turf 101 is configured by a base 110 have a carpet shape, a turf layer 120 formed by a plurality of fibers implanted on the base 110 as an artificial hair, and a filler 130 filled in the turf layer 120.

Here, the base 110 may be configured by a base fabric in which the fibers are implanted, and a back coating fixing the implanted fibers not to be removed.

In such an artificial turf, the fibers configuring the base 110 and the turf layer 120 are manufactured by using thermosetting chemical fibers as a fiber structure, and the filler 130 is manufactured in a form where a particulate silica 131 and an elastic body 133 such as rubber or silicon particles are filled in the turf layer.

A lifespan of such an artificial turf is expired when several years elapse after installation and thus replacement of the artificial turf is inevitable.

In the expired artificial turf, since the filler is strongly stamped in the turf layer during a use time, it is very difficult to separate the filler from the artificial turf, and even though the filler is separated, the artificial turf is not recycled by the remaining filler in the artificial turf and foreign materials accumulated during the use time.

As a result, even though the materials configuring the artificial turf may be recycled, after the expired artificial turf is collected, the entire quantity thereof is incinerated and wasted. Accordingly, there is a problem in that a waste of resources and environmental pollution are caused.

### DISCLOSURE

### Technical Problem

Therefore, an aspect of the present invention provides a recycling method of an artificial turf including a fiber structure having advantages of preventing environmental pollution by perfectly separating a filler and foreign materials from a base and fibers configuring the artificial turf to recycle the fibers and the base of the artificial turf and the filler.

### Technical Solution

According to an aspect of the present invention, there is provided a recycling method of an artificial turf including a fiber structure including: a supplying step of supplying an artificial turf configured by a base, a filler, and fibers; a separating step of separating the filler from the fibers and the base of the artificial turf; a crushing step of crushing the fibers and the base of the artificial turf from which the filler is separated; and a reproducing step of forming the crushed fibers and base of the artificial turf as a recycled material.

Here, the filler may be an elastic body, and the separating step may include an elastic body separating step of separating the elastic body from the artificial turf.

Further, the filler may be a silica, and the separating step may include a silica separating step of separating the silica from the artificial turf.

Further, the filler may be the elastic body and the silica, and the separating step may include an elastic body separating step of separating the elastic body from the artificial turf, and a silica separating step of separating the silica from the artificial turf.

Meanwhile, the recycling method may further include a collecting step of collecting the artificial turf from which the filler is separated.

In addition, the recycling method may further include a residual filler removing step of removing a residual filler included in the crushed fibers and base of the artificial turf after the crushing step.

Further, the recycling method may further include an additional separating step of separating the elastic body and the silica in the filler removed in the residual filler removing step.

In this case, the additional separating step may be one selected from particle separation, gravity separation, and electrostatic separation methods or a combination thereof.

Meanwhile, the crushing step may include a cutting step of cutting the fibers and the base of the artificial turf, and a particle crushing step of crushing the cut fibers and base to particles.

Further, the recycling method may further include a particle separating step of separating residual filler particles of the particles included in the fibers and the base of the artificial turf which are crushed to the particles.

In this case, the particle separating step may be one selected from particle separation, gravity separation, and electrostatic separation methods or a combination thereof.

Here, the gravity separating method may be one selected from wind power, dry cyclone, or wet cyclone, or a combination thereof, and the particle separating method may be one selected from trommel and sieving separation method, or a combination thereof.

Meanwhile, the recycling method may further include a cleaning step of cleaning the fibers and the base of the artificial turf after the residual filler removing step (crushed in the crushing step); and a drying step of drying the dried fibers and base of the artificial turf.

Here, the cleaning step may include a cleaning step of cleaning the crushed fibers and base of the artificial turf, and a foreign material removing step of removing a foreign material separated from the crushed fibers and base of the artificial turf in the cleaning step.

In this case, the cleaning step may be a step of cleaning the crushed fibers and base of the artificial turf in a cleaning bath where cleaning water is received, and the foreign material removing step may be a step of removing a floating foreign material floated in the cleaning bath and a precipitated foreign material.

In addition, the drying step may be performed by at least one method selected from centrifugal dehydration drying, pressing dehydration drying, air spray drying, and hot wind drying.

Meanwhile, the reproducing step may be a step of forming the crushed fibers and base of the artificial turf to a solid reproduction material by extrusion or injection.

Further, the recycling method may further include a filler reproducing step of forming the separated filler to the reproduction material.

### Advantageous Effects

According to the present invention, it is possible to a recycling method of an artificial turf including a fiber structure having advantages of preventing environmental pollution by perfectly separating a filler and foreign materials from a base and fibers configuring the artificial turf to recycle the fibers and the base of the artificial turf and the filler.

### DESCRIPTION OF DRAWINGS

FIG. 1 is a cross-sectional view of a general artificial turf.

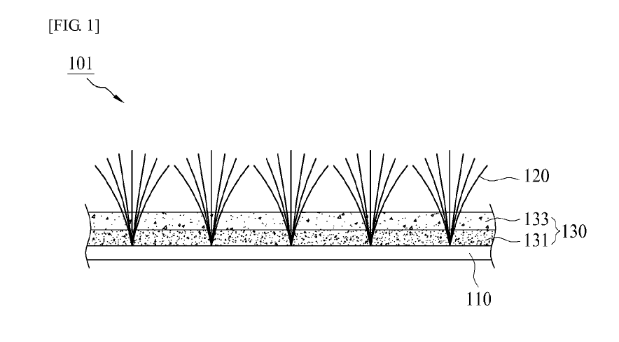

FIG. 2 is a process flowchart of recycling an artificial turf according to a first embodiment of the present invention.

FIG. 3 is a process flowchart of recycling an artificial turf according to a second embodiment of the present invention.

FIG. 4 is a process flowchart of recycling an artificial turf according to a third embodiment of the present invention.

### DETAILED DESCRIPTION

Hereinafter, the present invention will be described in detail with reference to the accompanying drawing.

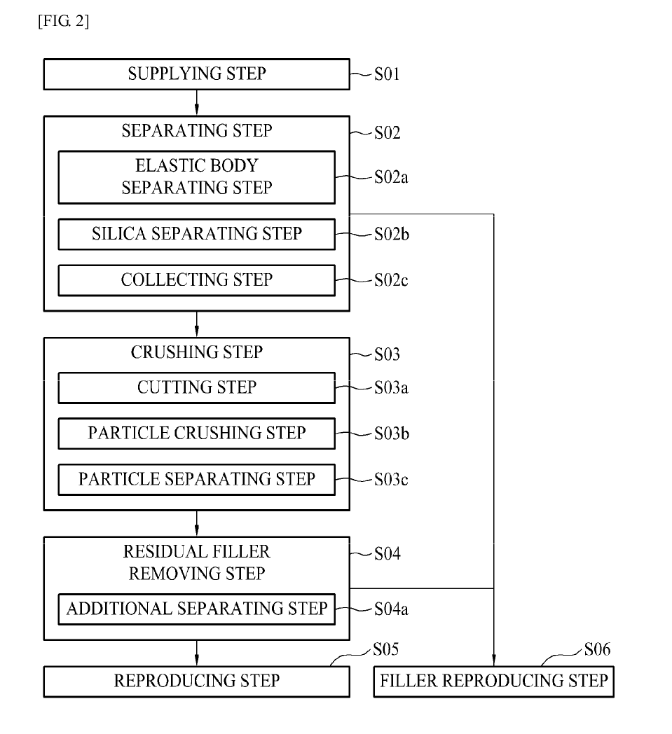

FIG. 2 is a process flowchart of a recycling method of an artificial turf including a fiber structure according to a first embodiment of the present invention. As illustrated in FIG. 2, a recycling method of an artificial turf including a fiber structure according to a first embodiment of the present invention includes a supplying step of supplying an artificial turf configured by a base, a filler, and fibers (S01), a separating step of separating the filler included in the artificial turf to collect the artificial turf fibers and the base (S02), a crushing step of crushing the fibers and the base of the artificial turf from which the filler is separated (S03), a removing step of removing a residual filler included in the crushed fibers and base of the artificial turf (S04), and a reproducing step of forming the fibers and the base of the artificial turf from which the residual filler is removed, with a recycled material (S05).

In the supplying step (S01), as a step of supplying an expired artificial turf collected from various outdoor stadiums and school grounds, the supplied artificial turf may be supplied by a predetermined area unit or length unit.

The separating step (S02), as a step of separating an elastic body and a silica which are the filler included in the turf layer of the artificial turf, includes an elastic body separating step of separating the elastic body from the artificial turf (S02a), a silica separating step of separating the silica from the artificial turf (S02b), and a collecting step of collecting an artificial turf fabric in which the elastic body and the silica are separated (S02c).

In the elastic body separating step (S02a), as a step of separating the elastic body filled in an upper region of the turf layer of the artificial turf, the separating of the elastic body may be performed by at least one of methods such as brushing, scraping, beating, air blowing, and air suction. The elastic body separated from the artificial turf is separately collected to be reproduced in a filler reproducing step (S06) and recycled.

Here, the filler included in the artificial turf may be made of only either the elastic body or the silica, and when the filler is made of only the silica, although not illustrated, in the separating step (S02), the elastic body separating step (S02a) may be omitted.

In the silica separating step (S02b), as a step of separating the silica remaining in a lower region of the turf layer of the artificial turf from which the elastic body is separated, the separating of the silica may also be performed by at least one of methods such as brushing, scraping, beating, air blowing, and air suction. The silica separated from the artificial turf is also separately collected to be reproduced in a filler reproducing step (S06) to be described below and recycled.

Here, the filler included in the artificial turf may be made of only either the elastic body or the silica, and when the filler is made of only the elastic body, although not illustrated, in the separating step (S02), the silica separating step (S02b) may be omitted.

In the collecting step (S02c), the collecting process may be performed by winding the fibers and the base of the artificial turf from which the elastic body and the silica are separated or cutting the fibers and the base with a predetermined size.

Here, the separating process (S02) may be configured only by the elastic separating step (S02a) and the collecting step (S02c) when the filler included in the artificial turf is made of only the elastic body, and may be configured only by the silica separating step (S02b) and the collecting step (S02c) when the filler included in the artificial turf is made of only the silica.

Meanwhile, the crushing step (S03) includes a cutting step of cutting the fibers and the base of the artificial turf (S03a), a particle crushing step of crushing the cut fibers and base of the artificial turf with particles (S03b), and a particle separating step of separating residual filler particles on the particles included in the crushed fibers and base of the artificial turf (S03c).

The cutting step (S03a) may be performed by a process of cutting the fibers and base of the artificial turf by a drum type crusher with a saw blade. This is to minimize the damage and the property deterioration of the fibers in the cutting process of the fibers and the base of the artificial turf, and may increase separation efficiency of the fibers, the residual filler, and the base in the particle separating step (S03c) by finely cutting the base while the fibers are maintained in theirs original state.

Here, the cutting step (S03a) may use various cutting methods such as a method of cutting the artificial turf with a predetermined size without directivity and a method of cutting only the fibers in the base and cutting again the remainder.

The particle crushing step (S03b) is a process of crushing the cut fibers and base of the artificial turf to a particle form by using a crushing apparatus. In this process, the fibers and base of the artificial turf and the residual filler are crushed to particles.

The particle separating step (S03c) is a process of separating the fiber particles and base particles of the artificial turf and the residual filler particles. This process may be performed by one selected from a gravity separating method and an electrostatic separating method, or a combined separating method thereof.

Here, the gravity separating method may be one selected from wind power, dry cyclone, or wet cyclone, or a combination thereof, and the particle separating method may be one selected from trommel and sieving separation method, or a combination thereof. Further, the electrostatic separation may be a method using electrostatic.

The filler particles of the particles separated in the particle separating step (S03c) are separately collected and recycled, and the remaining crushed fiber particles and base particles of the artificial turf are reproduced to a material for recycling in the reproducing step (S05).

Meanwhile, the residual filler removing step (S04) may be performed by a process of separating the residual filler included in the crushed fibers and base of the artificial turf by one method selected from the particle separation, the gravity separation, and the electrostatic separation, or a combination method thereof.

The particle separation may separate the residual filler from the crushed fibers and base of the artificial turf by using a method such as sieve separation using a reticular body, vacuum sieve separation, or trommel. In addition, the gravity separation may separate the residual filler from the crushed fibers and base of the artificial turf by using a wind power separation apparatus, or a dry or wet cyclone. Further, the electrostatic separation may separate the residual filler from the crushed fibers and base of the artificial turf by using electrostatic.

Further, the residual filler removing step (S04) may include an additional separating step (S04a) of separating the elastic body and the silica from the separated residual filler. The additional separating step (S04a) may be performed by one selected from a particle separating method, a gravity separating method, and an electrostatic separating method, or a combined separating method thereof, as described above.

Further, in the residual filler removing step (S04), the separated residual filler is separately collected to be reproduced in the filler reproducing step (S06) to be described below and recycled.

Meanwhile, the reproducing step (S05) is a process of forming the crushed fibers and base of the artificial turf from which the residual filler is removed to a solid reproduction material having a predetermined form, and the crushed fibers and base of the artificial turf may be formed with the solid reproduction material by using an extrusion or injection method.

Here, after the crushed fibers and base of the artificial turf are kneaded, the kneaded material is formed with the solid reproduction material by the extrusion or injection method to more efficiently obtain the solid reproduction material.

Further, a predetermined amount of a new raw material of the same material as the crushed fibers and base of the artificial turf is mixed to form the solid reproduction material having more excellent quality by the extrusion or injection method after the extrusion or injection and the kneading descried above.

Meanwhile, the recycling method of the artificial turf including the fiber structure according to the first exemplary embodiment may further include a filler reproducing step (S06) for recycling the separated and collected filler in the separating step (S02) and the residual filler removing step (S04) descried above.

The filler reproducing step (S06) may be performed by a process of cleaning and drying the silica or the elastic body which is the filler, a process of removing the foreign materials included in the filler, and the like.

As such, the recycling method of the artificial turf including the fiber structure according to the exemplary embodiment may ensure the fabric and the base of the artificial turf which have high purity to the crushed fibers and base of the artificial turf by perfectly separating the filler included in the artificial turf through the supplying step (S01), the separating step (S02), the crushing step (S03), and the residual filler removing step (S04), and use the fibers and base of the artificial turf as a reproduction material for manufacturing the artificial turf by forming the crushed fibers and base of the artificial turf to the solid reproduction material in the reproducing step (S05). Further, the filler separated from the artificial turf may be reproduced and recycled in the filler reproducing step (S06). As a result, it may contribute to resource saving and prevention of environmental pollution.

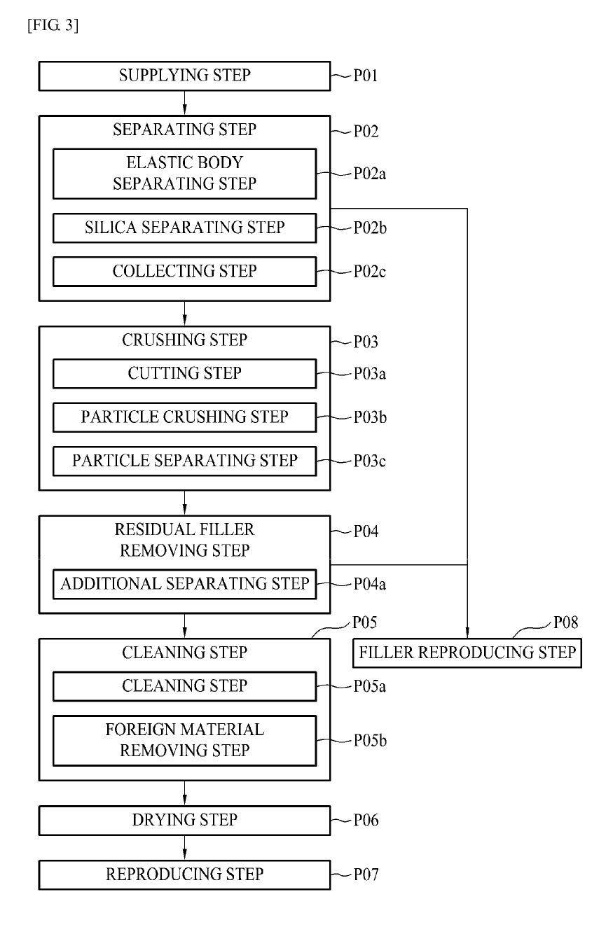

Meanwhile, FIG. 3 is a process flowchart of a recycling method of an artificial turf including a fiber structure according to a second embodiment of the present invention. As illustrated in FIG. 3, the recycling method of the artificial turf including a fiber structure according to the embodiment includes a supplying step (P01), a separating step (P02), a crushing step (P03), a residual filler removing step (P04), a reproducing step (P07), and a filler reproducing step (P08) like the aforementioned recycling method of the artificial turf including a fiber structure according to the first embodiment, and further includes a cleaning step (P05) of cleaning the crushed fibers and base of the artificial turf from which the residual filler is removed after the residual filler removing step (P04) and a drying step of drying the crushed fibers and base of the cleaned artificial turf (P06).

Here, since the supplying step (P01), the separating step (P02), the crushing step (P03), the residual filler removing step (P04), the reproducing step (P07), and the filler reproducing step (P08) are the same as the aforementioned first embodiment, the description is omitted. In this case, an elastic body separating step (P02a), a silica separating step (P02b), and a collecting step (P02c) in the separating step (P02), a cutting step (P03a), a particle crushing step (P03b), and a particle separating step (P03c) in the crushing step (P03), and an additional separating step (P04a) in the residual filler removing step (P04) are also the same as the aforementioned first embodiment.

The cleaning step (P05) may be divided into a cleaning step (P05a) of cleaning the crushed fibers and base of the artificial turf from which the residual filler is removed and a foreign material removing step (P05b) of removing the foreign materials separated from the crushed fibers and base of the artificial turf (P05b).

The cleaning step (P05a) may be performed in a form where the crushed fibers and base of the artificial turf from which the residual filler is removed is cleaned in a cleaning bath where cleaning water is received. In this case, the cleaning water received in the cleaning bath may be continuously circulated or circulated at a predetermined interval. The circulated cleaning water may perform a separate purification process.

The crushed fibers and base of the artificial turf put in the cleaning bath is left in the cleaning bath for a predetermined time and then drawn out from the cleaning bath to move to the drying step (P06).

The foreign material removing step (P05b) is a process of removing the foreign material separated from the crushed fibers and base of the artificial turf while the crushed fibers and base of the artificial turf is left in the cleaning bath, and the foreign material removing step (P05b) may be divided into a process of removing a floating foreign material floated in the cleaning bath according to a specific gravity of the foreign material and a process of removing a precipitated foreign material. The foreign material removing step (P05b) may be implemented by a separate foreign material removing apparatus provided on a water surface or under water and a bottom under water of the cleaning bath.

Meanwhile, the drying step (P06) is a process of removing moisture remaining in the crushed fibers and base of the artificial turf which are cleaned in the cleaning step (P05), and the crushed fibers and base of the artificial turf may be dried by at least one of a dehydration drying method using centrifugal force, a dehydration drying method by pressing, a dehydration drying method by spraying air, or a dehydration drying method using a hot wind. Of course, as the method of drying the crushed fibers and base of the artificial turf, a naturally drying method may be selected.

The crushed fibers and base of the artificial turf through the drying step (P06) is formed to the solid reproducing material by moving to the reproducing step (P07) like the aforementioned first embodiment.

As such, the recycling method of the artificial turf including the fiber structure according to the embodiment includes the cleaning step (P05) and the drying step (P06) to perfectly separate the filler included in the artificial turf and the foreign materials and ensure the crushed fibers and base of the artificial turf having high purity.

The crushed fibers and base of the artificial turf having high purity are formed to the solid reproduction material in the reproducing step (P07), and thus the fibers and base of the artificial turf may be used as the reproducing material for manufacturing the artificial turf again. Further, the filler separated from the artificial turf may be reproduced in the filler reproducing step (S06) and recycled. As a result, it may contribute to resource saving and prevention of environmental pollution.

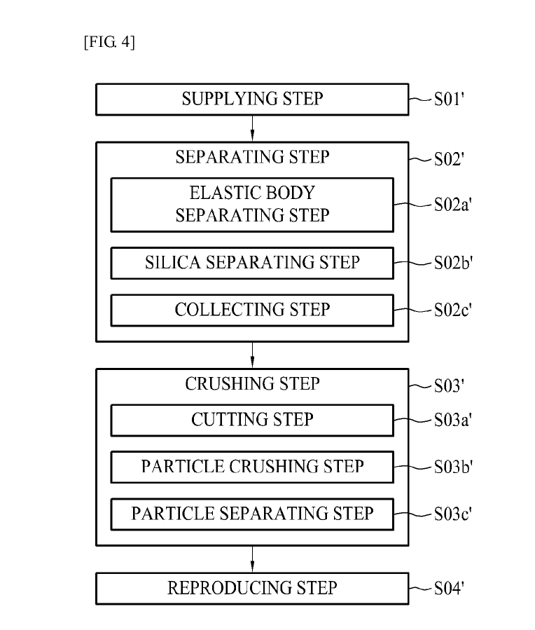

Meanwhile, FIG. 4 is a process flowchart of a recycling method of an artificial turf including a fiber structure according to a third embodiment of the present invention. As illustrated in FIG. 4, the recycling method of the artificial turf including the fiber structure according to the embodiment may omit the residual filler removing step, the cleaning step, the drying step, and the filler reproducing step in the recycling methods of the artificial turf including the fiber structure according to the aforementioned first embodiment and second embodiment, and may be configured by a supplying step (S01′), a separating step (S02′), a crushing step (S03′), and a reproducing step (S04′).

Here, since the supplying step (S01′), the separating step (S02′), the crushing step (S03′), and the reproducing step (S04′) are the same as the aforementioned embodiments, the description is omitted. In this case, an elastic body separating step (S02a′) and a silica separating step (S02b′), and a collecting step (S02c′) in the separating step (S02′), and a cutting step (S03a′), a particle crushing step (S03b′), and a particle separating step (S03c′) in the crushing step (S03′) are also the same as the aforementioned embodiments.

The recycling method of the artificial turf including the fiber structure according to the embodiment provides a method of separating and collecting the fibers and base of the artificial turf having high purity to be formed as the solid reproduction material by a simple process.

In this case, the filler separated from the artificial turf may be recycled in a state separated according to the purity, and may be recycled through a separate reproducing process.

As a result, the recycling method of the artificial turf including the fiber structure is simplified to promote reduction of cost and equipment and contribute to resource saving and prevention of environmental pollution.

As described above, according to the present invention, it is possible to a recycling method of an artificial turf including a fiber structure capable of preventing environmental pollution by perfectly separating a filler and foreign materials from a base and fibers configuring the artificial turf to recycle the fibers and the base of the artificial turf and the filler.

### INDUSTRIAL APPLICABILITY

It is possible to contribute to resource saving and prevention of environmental pollution by recycling the fibers and the base configuring the artificial turf and the filler.

1. A recycling method of an artificial turf including a fiber structure, comprising:
a supplying step of supplying an artificial turf configured by a base, a filler, and fibers;
a separating step of separating the filler from the fibers and the base of the artificial turf;
a crushing step of crushing the fibers and the base of the artificial turf from which the filler is separated; and
a reproducing step of forming the crushed fibers and base of the artificial turf as a recycled material.

2. The recycling method of claim 1, wherein the filler is an elastic body, and the separating step includes an elastic body separating step of separating the elastic body from the artificial turf.

3. The recycling method of claim 1, wherein the filler is a silica, and the separating step includes a silica separating step of separating the silica from the artificial turf.

4. The recycling method of claim 1, wherein the filler is the elastic body and the silica, and the separating step includes an elastic body separating step of separating the elastic body from the artificial turf, and a silica separating step of separating the silica from the artificial turf.

5. The recycling method of claim 1, further comprising:
a collecting step of collecting the artificial turf from which the filler is separated.

6. The recycling method of claim 1, further comprising:
a residual filler removing step of removing a residual filler included in the crushed fibers and base of the artificial turf after the crushing step.

7. The recycling method of claim 6, further comprising:
an additional separating step of separating the elastic body and the silica in the filler removed in the residual filler removing step.

8. The recycling method of claim 7, wherein the additional separating step is one selected from particle separation, gravity separation, and electrostatic separation methods or a combination thereof.

9. The recycling method of claim 1, wherein the crushing step includes a cutting step of cutting the fibers and the base of the artificial turf, and a particle crushing step of crushing the cut fibers and base to particles.

10. The recycling method of claim 9, further comprising:
a particle separating step of separating residual filler particles of the particles included in the fibers and the base of the artificial turf which are crushed to the particles.

11. The recycling method of claim 10, wherein the particle separating step is one selected from particle separation, gravity separation, and electrostatic separation methods or a combination thereof.

12. The recycling method of claim 8, wherein the gravity separating method is one selected from wind power, dry cyclone, or wet cyclone, or a combination thereof, and the particle separating method is one selected from trommel and sieving separation method, or a combination thereof.

13. The recycling method of claim 6, further comprising:
a cleaning step of cleaning the fibers and the base of the artificial turf after the residual filler removing step; and
a drying step of drying the dried fibers and base of the artificial turf.

14. The recycling method of claim 13, wherein the cleaning step includes a cleaning step of cleaning the crushed fibers and base of the artificial turf, and a foreign material removing step of removing a foreign material separated from the crushed fibers and base of the artificial turf in the cleaning step.

15. The recycling method of claim 14, wherein the cleaning step is a step of cleaning the crushed fibers and base of the artificial turf in a cleaning bath where cleaning water is received, and the foreign material removing step is a step of removing a floating foreign material floated in the cleaning bath and a precipitated foreign material.

16. The recycling method of claim 13, wherein the drying step is performed by at least one method selected from centrifugal dehydration drying, pressing dehydration drying, air spray drying, and hot wind drying.

17. The recycling method of claim 1, wherein the reproducing step is a step of forming the crushed fibers and base of the artificial turf to a solid reproduction material by extrusion or injection.

18. The recycling method of claim 1, further comprising:
a filler reproducing step of forming the separated filler to the reproduction material.
